(19) United States
(12) Patent Application Publication
(10) Pub. No.: US 2003/0046705 A1
(43) Pub. Date: Mar. 6, 2003

(54) System and method for enabling communication between video-enabled and non-video-enabled communication devices

(76) Inventor: Michael E. Sears, Bellevue, WA (US)

Correspondence Address: DIGEO, INC C/O STOEL RIVES LLP, 201 SOUTH MAIN STREET, SUITE 1100, ONE UTAH CENTER, SALT LAKE CITY, UT, 84111, US

(21) Appl. No.: 09/941,239

(22) Filed: Aug. 28, 2001

(51) Int. Cl. H04N 7/173; H04L 12/403; H04L 12/42; H04J 1/00; H04H 1/04

(52) U.S. Cl. 725/106; 725/131; 725/117; 725/119; 370/486; 370/449

(57) ABSTRACT

In response to a request to establish video communication between a video-enabled (e.g., videophone) and non-video-enabled (e.g., cellular telephone) communication device, two-way audio communication is established between the two devices. One-way video communication is also established between a server and the video-enabled device. Video signals generated by the video-enabled device during the two-way audio communication are captured and cached within the server. The cached video signals may be subsequently retrieved and displayed by a computer terminal or video-enabled communication device.

### BACKGROUND

1. Field of the Invention

The present invention relates generally to the field of interactive television systems. More specifically, the present invention relates to a system and method for and enabling communication between video-enabled and non-video-enabled communication devices.

2. Description of Related Background Art

Videophones enable users to communicate visually without the expense or time required for in-person meetings. Using a videophone, for example, a design engineer may show his supervisor a prototype of a product being developed, even though the parties may be in different cities, states, or countries. The useful applications of videophones are endless.

However, difficulties arise when video-enabled communication devices, such as videophones, attempt to communicate with conventional, non-video-enabled communication devices, such as telephones or cellular telephones. Typically, the attempt will fail, since video-enabled and non-video-enabled communication devices use different communication protocols, networks, etc.

Even if an audio-only communication could be established between the devices, the video information captured by the video-enabled device would be irretrievably lost. A user of the non-video-enabled device could not, at a subsequent time, review the captured video information.

Thus, it would be an advancement in the art to provide a system and method for enabling communication between a video-enabled and non-video-enabled communication devices, while providing a user of the non-video-enabled device with subsequent access to the video information captured by the video-enable device during a communication session.

### BRIEF DESCRIPTION OF THE DRAWINGS

Non-exhaustive embodiments of the invention are described with reference to the figures, in which:

FIG. 1 is a block diagram of a communication system;

FIG. 2 is an illustration of an interactive television system;

FIG. 3 is a block diagram of physical components of a set top box (STB);

FIG. 4 is a high-level block diagram of physical components of a broadcast center;

FIG. 5 is a dataflow diagram illustrating the capture of video signals during two-way audio communication between video-enabled and non-video-enabled communication devices;

FIG. 6 is a dataflow diagram illustrating the display of previously captured and stored video signals;

FIG. 7 is a block diagram of logical components of a system for enabling communication between video-enabled and non-video-enabled communication devices; and

FIG. 8 is a flowchart of a method for enabling communication between video-enabled and non-video-enabled communication devices.

### DETAILED DESCRIPTION OF THE PREFERRED EMBODIMENTS

The present invention solves the foregoing problems and disadvantages by providing a system and method for enabling communication between video-enabled and non-video-enabled communications devices while providing users with access to cached video information.

In one implementation, a request is detected to establish video communication between a video-enabled and a non-video-enabled communication device (e.g., between a videophone and a conventional cellular telephone). The request may be embodied in any suitable format according to the devices and/or software being used.

After determining that the non-video-enabled device cannot display video information, two-way audio communication is established between the two devices. In one embodiment, during two-way audio communication, video signals generated by the video-enabled device are captured and cached by a server. The server may be implemented within an intermediate network node linking the devices, such as a cable head-end, satellite broadcast center, Internet server, or the like. Alternatively, the server may be implemented within the video-enabled device, itself.

At a later time, the user of the non-video-enabled device (or other authorized user) may access the server and retrieve the cached video signals for display on a network terminal or video-enabled communication device.

In one implementation, audio signals (in one or both directions) may also be captured and cached during communication between the video-enabled and non-video-enabled devices. These audio signals may be later retrieved and played back on a requesting terminal synchronously with the cached video signals, allowing a user to experience the entire communication.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. In the following description, numerous specific details are provided, such as examples of programming, user selections, network transactions, database queries, database structures, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

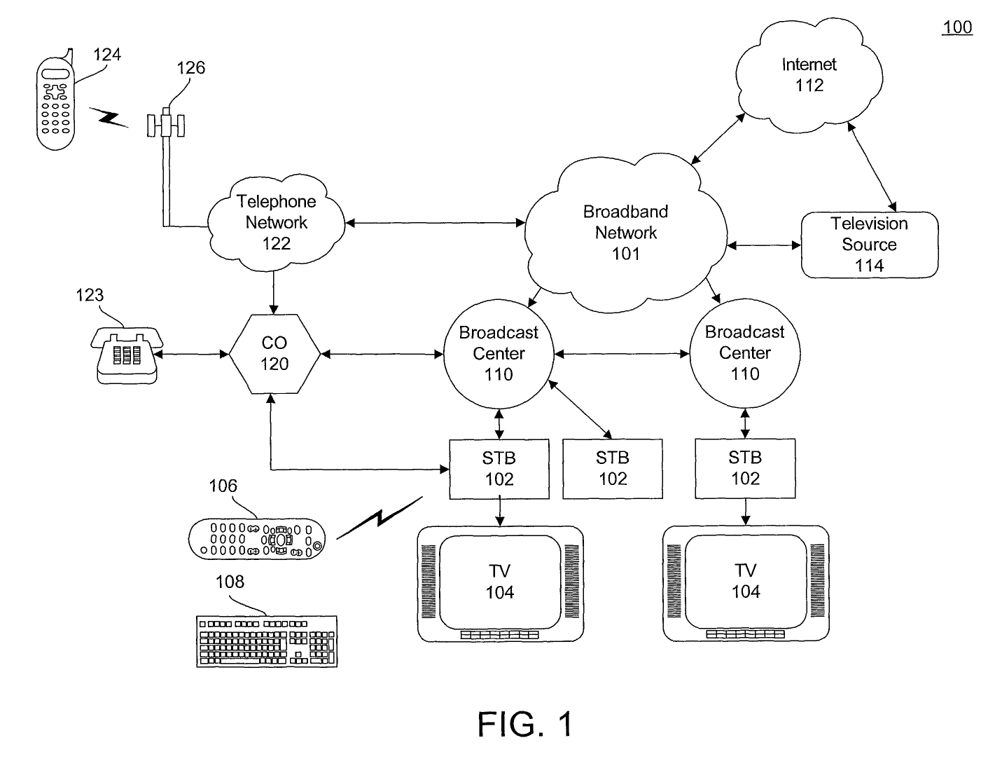

Referring now to FIG. 1, there is shown a communication system 100 according to an embodiment of the invention. In one implementation, the system 100 relies on a broadband network 101 for communication, such as a cable network or a direct satellite broadcast (DBS) network, although other networks are possible.

The system 100 may include a plurality of set top boxes (STBs) 102 located, for instance, at customer homes or offices. Generally, an STB 102 is a consumer electronics device that serves as a gateway between a customer's television 104 and the network 101. In alternative embodiments, an STB 102 may be embodied more generally as a personal computer (PC), an advanced television 104 with STB functionality, a personal digital assistant (PDA), or the like.

An STB 102 receives encoded television signals and other information from the network 101 and decodes the same for display on the television 104 or other display device (such as a computer monitor). As its name implies, an STB 102 is typically located on top of, or in close proximity to, the television 104.

Each STB 102 may be distinguished from other network components by a unique identifier, number, code, or address, examples of which include an Internet Protocol (IP) address (e.g., an IPv6 address), a Media Access Control (MAC) address, or the like. Thus, video streams and other information may be transmitted from the network 101 to a specific STB 102 by specifying the corresponding address, after which the network 101 routes the transmission to its destination using conventional techniques.

A remote control 106 is provided, in one configuration, for convenient remote operation of the STB 102 and the television 104. The remote control 106 may use infrared (IR), radio frequency (RF), or other wireless technologies to transmit control signals to the STB 102 and the television 104. Other remote control devices are also contemplated, such as a wired or wireless mouse (not shown).

Additionally, a keyboard 108 (either wireless or wired) is provided, in one embodiment, to allow a user to rapidly enter text information into the STB 102. Such text information may be used for e-mail, instant messaging (e.g. text-based chat), or the like. In various embodiments, the keyboard 108 may use infrared (IR), radio frequency (RF), or other wireless technologies to transmit keystroke data to the STB 102.

Each STB 102 may be coupled to the network 101 via a broadcast center 110. In the context of a cable network, a broadcast center 110 may be embodied as a “head-end”, which is generally a centrally-located facility within a community where television programming is received from a local cable TV satellite downlink or other source and packaged together for transmission to customer homes. In one configuration, a head-end also functions as a Central Office (CO) in the telecommunication industry, routing video streams and other data to and from the various STBs 102 serviced thereby.

A broadcast center 110 may also be embodied as a satellite broadcast center within a direct broadcast satellite (DBS) system. A DBS system may utilize a small 18-inch satellite dish, which is an antenna for receiving a satellite broadcast signal. Each STB 102 may be integrated with a digital integrated receiver/decoder (IRD), which separates each channel, and decompresses and translates the digital signal from the satellite dish to be displayed by the television 104.

Programming for a DBS system may be distributed, for example, by multiple high-power satellites in geosynchronous orbit, each with multiple transponders. Compression (e.g., MPEG) may be used to increase the amount of programming that can be transmitted in the available bandwidth.

The broadcast centers 110 may be used to gather programming content, ensure its digital quality, and uplink the signal to the satellites. Programming may be received by the broadcast centers 110 from content providers (CNN, ESPN, HBO, TBS, etc.) via satellite, fiber optic cable and/or special digital tape. Satellite-delivered programming is typically immediately digitized, encrypted and uplinked to the orbiting satellites. The satellites retransmit the signal back down to every earth-station, e.g., every compatible DBS system receiver dish at customers' homes and businesses.

Some broadcast programs may be recorded on digital videotape in the broadcast center 110 to be broadcast later. Before any recorded programs are viewed by customers, technicians may use post-production equipment to view and analyze each tape to ensure audio and video quality. Tapes may then be loaded into a robotic tape handling systems, and playback may be triggered by a computerized signal sent from a broadcast automation system. Back-up videotape playback equipment may ensure uninterrupted transmission at all times.

Regardless of the nature of the network 101, the broadcast centers 110 may be coupled directly to one another or through the network 101. In alternative embodiments, broadcast centers 110 may be connected via a separate network, one particular example of which is the Internet 112. The Internet 112 is a “network of networks” and is well known to those skilled in the art. Communication over the Internet 112 is accomplished using standard protocols, such as TCP/IP (Transmission Control Protocol/Internet Protocol), and the like.

A broadcast center 110 may receive television programming for distribution to the STBs 102 from one or more television programming sources 114 coupled to the network 101. Preferably, television programs are distributed in an encoded format, such as MPEG (Moving Picture Experts Group). MPEG is a form of predictive coding. In predictive coding, how and how much a next image changes from a previous one is calculated, and codes are transmitted indicating the difference between images rather than the image itself. In MPEG, the images or frames in a sequence are typically classified into three types: I frames, P frames, and B frames. An I frame or intrapicture is an image that is coded without reference to any other images. A P frame or predicted picture is an image that is coded relative to one other image. A B frame or bidirectional picture is an image that is derived from two other images, one before and one after.

Various MPEG standards are known, such as MPEG-2, MPEG-4, MPEG-7, and the like. Thus, the term “MPEG,” as used herein, contemplates all MPEG standards. Moreover, other video encoding/compression standards exist other than MPEG, such as JPEG, JPEG-LS, H.261, and H.263. Accordingly, the invention should not be construed as being limited only to MPEG.

Broadcast centers 110 may be used to enable audio and video communications between STBs 102. Transmission between broadcast centers 110 may occur (i) via a direct peer-to-peer connection between broadcast centers 110, (ii) upstream from a first broadcast center 110 to the network 101 and then downstream to a second broadcast center 110, or (iii) via the Internet 112 or another network. For instance, a first STB 102 may send a video transmission upstream to a first broadcast center 110, then to a second broadcast center 110, and finally downstream to a second STB 102.

Broadcast centers 110 and/or STBs 102 may be linked by one or more Central Offices (COs) 120, which are nodes of a telephone network 122. The telephone network 122 may be embodied as a conventional public switched telephone network (PSTN), digital subscriber line (DSL) network, cellular network, or the like. The telephone network 122 may be coupled to a plurality of standard telephones 123, e.g. POTS. Additionally, the telephone network 122 may be in communication with a number of cellular telephones 124 via cellular telephone towers 126. Alternatively, a telephone may be configured as a “web phone”, which is coupled to the Internet 112 and uses various standard protocols, such as Voice-over-IP (VoIP) for communication.

Of course, the communication system 100 illustrated in FIG. 1 is merely exemplary, and other types of devices and networks may be used within the scope of the invention.

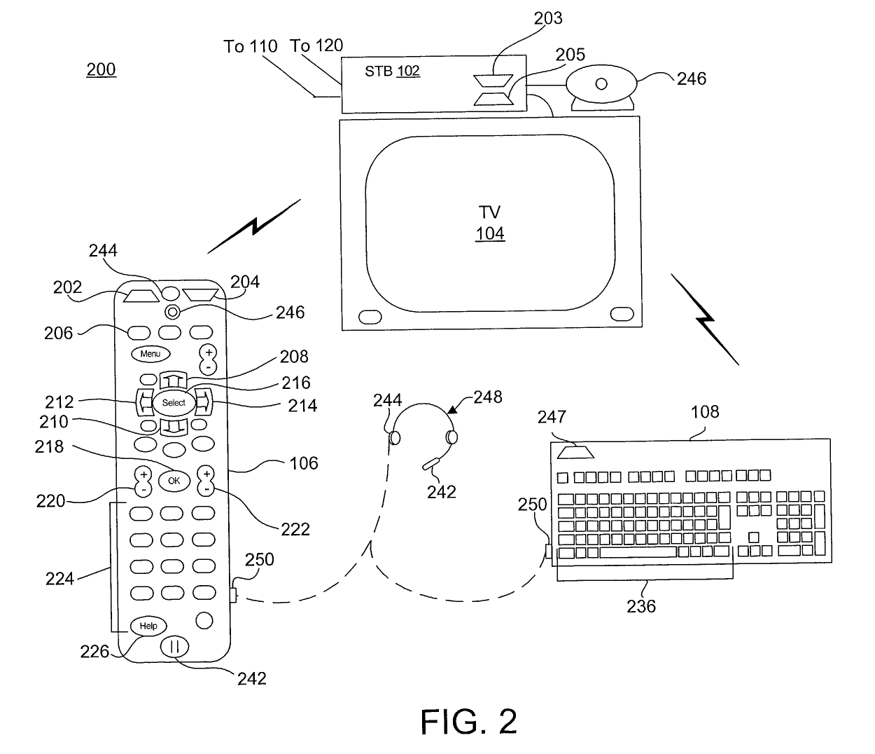

Referring now to FIG. 2, there is shown an interactive television (ITV) system 200 according to an embodiment of the invention. As depicted, the system 200 may include an STB 102, a television 104 (or other display device), a remote control 106, and, in certain configurations, a keyboard 108.

The remote control 106 is provided for convenient remote operation of the STB 102 and the television 104. In one configuration, the remote control 106 includes a wireless transmitter 202 for transmitting control signals (and possibly audio/video data) to a wireless receiver 203 within the STB 102 and/or the television 104. In certain embodiments, the remote control 106 includes a wireless receiver 204 for receiving signals from a wireless transmitter 205 within the STB 102. Operational details regarding the wireless transmitters 202, 205 and wireless receivers 203, 204 are generally well known to those of skill in the art.

The remote control 106 preferably includes a number of buttons or other similar controls. For instance, the remote control 106 may include a power button 206, an up arrow button 208, a down arrow button 210, a left arrow button 212, a right arrow button 214, a “Select” button 216, an “OK” button 218, channel adjustment buttons 220, volume adjustment buttons 222, alphanumeric buttons 224, a “Help” button 226, and the like.

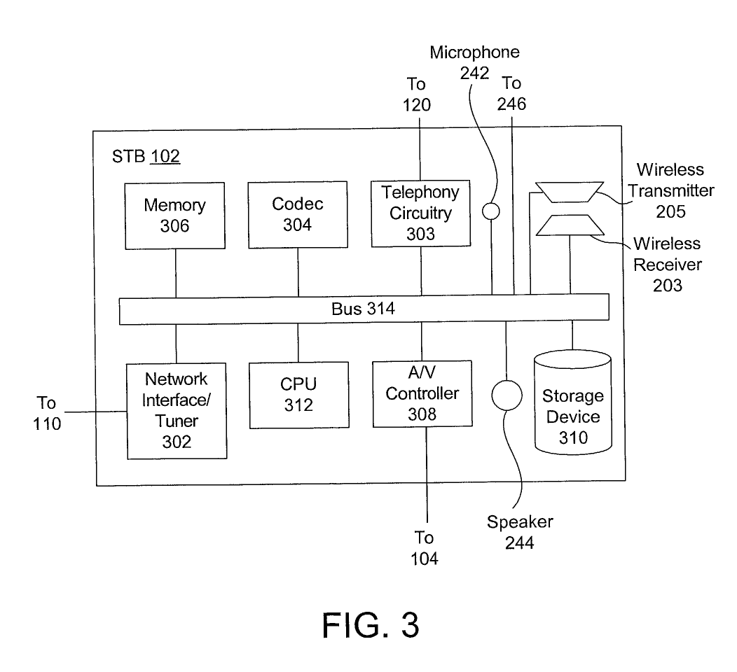

In one embodiment, the remote control 106 includes a microphone 242 for capturing audio signals. The captured audio signals are preferably transmitted to the STB 102 via the wireless transmitter 202. In addition, the remote control 106 may include a speaker 244 for generating audible output from audio signals received from the STB 102 via the wireless receiver 204. In alternative embodiments, as shown in FIG. 3, the microphone 242 and/or speaker 244 are integrated with the STB 102.

In certain embodiments, the remote control 106 further includes a video camera 246, such as a CCD (charge-coupled device) digital video camera, for capturing video signals. In one implementation, the video camera 246 is in electrical communication with the wireless transmitter 202 for sending the captured video signals to the STB 102. Alternatively, the video camera 246 may be integrated with the STB 102 or attached to the STB 102 as in the depicted embodiment.

The various components of the remote control 106 may be positioned in different locations for functionality and ergonomics. For example, as shown in FIG. 2, the speaker 244 may be positioned near the “top” of the remote control 106 (when viewed from the perspective of FIG. 2) and the microphone 242 may be positioned at the “bottom” of the remote control 106. Thus, in one embodiment, a user may conveniently position the speaker 244 near the user's ear and the microphone 242 near the user's mouth in order to operate the remote control 106 in the manner of a telephone.

The optional keyboard 108 facilitates rapid composition of text messages. The keyboard 108 preferably includes a plurality of standard alphanumeric keys 236. In one configuration, the keyboard 108 also includes a wireless transmitter 247, similar or identical to the wireless transmitter 202 of the remote control 106. The wireless transmitter 247 transmits keystroke data from the keyboard 108 to the STB 102. Additionally, the keyboard 108 may include one or more of the buttons illustrated on the remote control 106.

Alternatively, or in addition, a hands-free headset 248 may be coupled to the remote control 106 or the keyboard 108. The headset 248 may be coupled using a standard headset jack 250. The headset 248 may include a microphone 242 and/or speaker 244. Such a headset 248 may be used to reduce audio interference from the television 104 (improving audio quality) and to provide the convenience of hands-free operation.

Referring now to FIG. 3, there is shown a block diagram of physical components of an STB 102 according to an embodiment of the invention. As noted above, the STB 102 includes a wireless receiver 203 for receiving control signals sent by the wireless transmitter 202 in the remote control 106 and a wireless transmitter 205 for transmitting signals (such as audio/video signals) to the wireless receiver 204 in the remote control 106.

The STB 102 also includes, in one implementation, a network interface/tuner 302 for receiving television signals and/or other data from the network 101 via a broadcast center 110. The interface/tuner 302 may conventional include tuning circuitry for receiving, demodulating, and demultiplexing MPEG-encoded television signals. In certain embodiments, the interface/tuner 302 may include analog tuning circuitry for tuning to analog television signals.

The interface/tuner 302 may also include conventional modem circuitry for sending or receiving data. For example, the interface/tuner 302 may conform to the DOCSIS (Data Over Cable Service Interface Specification) or DAVIC (Digital Audio-Visual Council) cable modem standards. Of course, the network interface and tuning functions could be performed by separate components within the scope of the invention.

In one configuration, one or more frequency bands (for example, from 5 to 30 MHz) may be reserved for upstream transmission. Digital modulation (for example, quadrature amplitude modulation or vestigial sideband modulation) may be used to send digital signals in the upstream transmission. Of course, upstream transmission may be accomplished differently for different networks 101. Alternative ways to accomplish upstream transmission may include, for example, using a back channel transmission, which is typically sent via an analog telephone line, ISDN, DSL, etc.

The STB 102 may also include standard telephony circuitry 303 for establishing a two-way telephone connection between the STB 102 and a conventional telephone. In one embodiment, the telephony circuitry 303 transforms an audio signal received by wireless receiver 203 of the STB 102 into a telephony-grade audio signal for transmission via the telephone network 122. Likewise, the telephony circuitry 303 may receive a telephony-grade audio signal from the telephone network 122 and generate an audio signal compatible with the wireless transmitter 205 of the STB 102 for transmission to a speaker 244 in the remote control 106, STB 102, or the television 104. Alternatively, or in addition, the telephony circuitry 303 may include modem circuitry to allow audio, video, text, and control data to be transmitted via the telephone network 122.

The STB 102 may also include a codec (encoder/decoder) 304, which serves to encode audio/video signals into a network-compatible data stream for transmission over the network 101. The codec 304 also serves to decode a network-compatible data stream received from the network 101. The codec 304 may be implemented in hardware and/or software. Moreover, the codec 304 may use various algorithms, such as MPEG or Voice-over-IP (VoIP), for encoding and decoding.

The STB 102 further includes a memory device 306, such as a random access memory (RAM), for storing temporary data. In certain embodiments, the memory device 306 may include a read-only memory (ROM) for storing more permanent data, such as fixed code and configuration information.

In one embodiment, an audio/video (A/V) controller 308 is provided for converting digital audio/video signals into analog signals for playback/display on the television 104. The A/V controller 308 may be implemented using one or more physical devices, such as separate graphics and sound controllers. The A/V controller 308 may include graphics hardware for performing bit-block transfers (bit-blits) and other graphical operations for displaying a graphical user interface (GUI) on the television 104.

In some implementations, the STB 102 may include a storage device 310, such as a hard disk drive. The storage device 310 may be configured to store encoded television broadcasts and retrieve the same at a later time for display. The storage device 310 may be configured, in one embodiment, as a digital video recorder (DVR), enabling scheduled recording of television programs, pausing (buffering) live video, etc. The storage device 310 may also be used in various embodiments to store viewer preferences, parental lock settings, electronic program guide (EPG) data, passwords, e-mail messages, and the like. In one implementation, the storage device 310 also stores an operating system (OS) for the STB 102, such as Windows CE® or Linux®.

As noted above, the STB 102 may include, in certain embodiments, a microphone 242 and a speaker 244 for capturing and reproducing audio signals, respectively. The STB 102 may also include or be coupled to a video camera 246 for capturing video signals. These components may be included in lieu of or in addition to similar components in the remote control 106, keyboard 108, and/or television 104.

A CPU 312 controls the operation of the STB 102, including the other components thereof, which are coupled to the CPU 312 in one embodiment via a bus 314. The CPU 312 may be embodied as a microprocessor, a microcontroller, a digital signal processor (DSP) or other device known in the art. For instance, the CPU 312 may be embodied as an Intel® x86 microprocessor. As noted above, the CPU 312 may perform logical and arithmetic operations based on program code stored within the memory 306 or the storage device 310.

Of course, FIG. 3 illustrates only one possible configuration of an STB 102. Those skilled in the art will recognize that various other architectures and components may be provided within the scope of the invention. In addition, various standard components are not illustrated in order to avoid obscuring aspects of the invention.

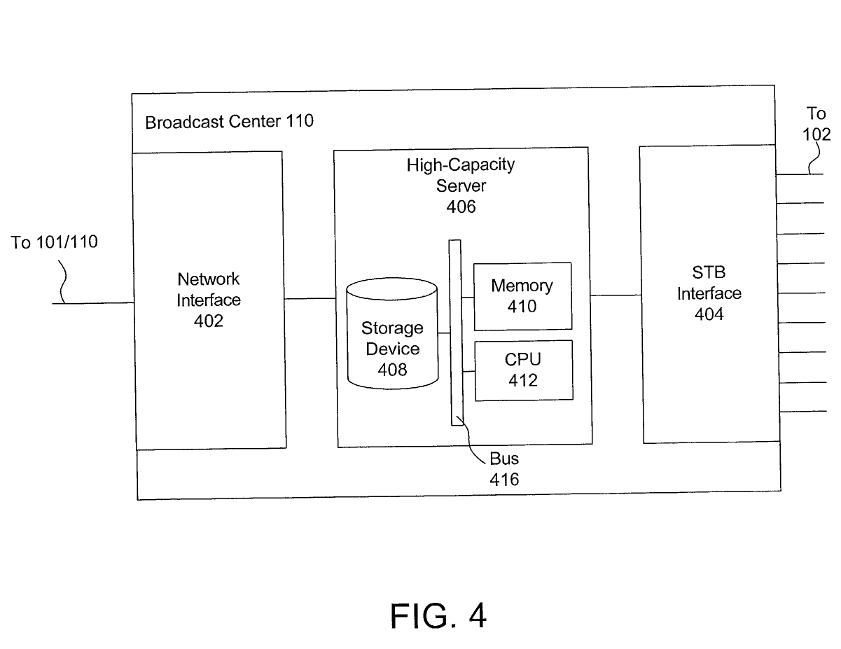

FIG. 4 is a high-level block diagram of physical components of a broadcast center 110 (e.g., a satellite broadcast center or a cable head-end). In one embodiment, the broadcast center 110 includes a network interface 402 for communicating with the network 101 and/or another broadcast center 110. The broadcast center 110 may also include an STB interface 404 for communicating with a plurality of STBs 102.

In one embodiment, the network interface 402 and the STB interface 404 are coupled to a high-capacity server 406. The high-capacity server 406 may be equipped with one or more storage devices 408, memories 410, CPUs 412, buses 416, and the like. While these components may perform essentially the same functions as those in the STB 102 of FIG. 2, they will typically be faster, have greater capacities, be able to handle more connections, etc. The high-capacity server 406 may further include specialized hardware and/or software for receiving satellite transmissions, for modulating and multiplexing video streams, for routing video streams between STBs 102, the network 101, and other broadcast centers 110, and the like.

Of course, FIG. 4 illustrates only one possible configuration of a broadcast center 110. Those skilled in the art will recognize that various other architectures and components may be provided within the scope of the invention. In addition, various standard components are not illustrated in order to avoid obscuring aspects of the invention.

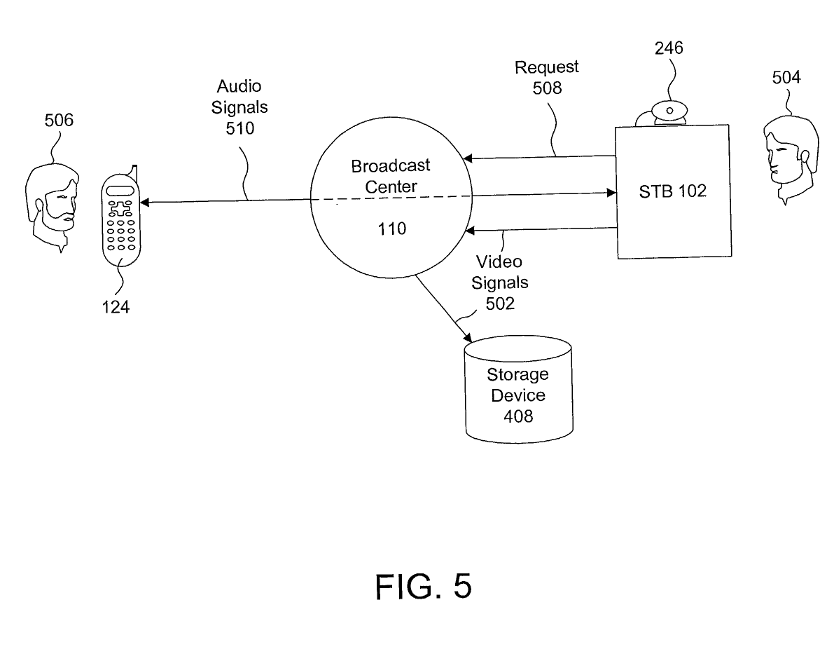

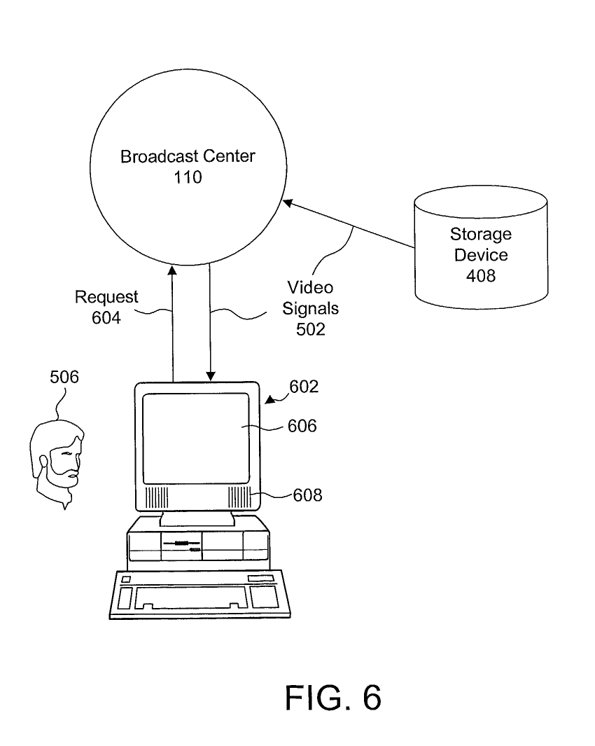

FIGS. 5-6 are high-level dataflow diagrams illustrating various operations and transactions according to embodiments of the invention. Of course, the illustrated embodiments may be modified in various ways without departing from the spirit and scope of the invention.

As shown in FIG. 5, a video-enabled communication device, such as an STB 102, may include a video camera 246 for capturing video signals. As used herein, the term “video-enabled” means that a communication device is capable of receiving and displaying video signals 502. Of course, a variety of other video-enabled communication devices are possible, such as dedicated videophones (e.g., the 2000T videophone by Aiptek, Inc. of Forest Lake, Calif.), PC-based video conferencing systems (e.g., Microsoft Netmeeting®, CuSeeMe®), and the like. Thus, while the following description makes particular reference to a camera-equipped STB 102 as an example of video-enabled communication device, the invention is not limited to STBs 102 or ITV systems 200 generally.

In the depicted embodiment, the video-enabled communication device (e.g., STB 102) attempts to establish video communication with a non-video-enabled device, such as a standard cellular telephone 124. However, in an alternative embodiment, the non-video-enabled device could attempt to establish communication with the video-enable device.

In some cases, the attempt might not be intentional. For example, a caller 504 may attempt to establish video communication with a videophone (not shown) of a recipient 506 by sending a video communication request 508. However, the recipient 506 may be away from his videophone and a forwarding system (not shown) identifies the recipient's cellular telephone 124 as the most probable communication device for reaching the recipient 506.

In one embodiment, a broadcast center 110 receives the request 508 (which may be embodied in any suitable format). The broadcast center 110 then determines that the non-video-enabled device (e.g., cellular telephone 124) is not capable of displaying video signals. This determination may be accomplished, for instance, by querying the device or maintaining a database of device capabilities.

The broadcast center 110 may then establish two-way audio communication between the STB 102 and the cellular telephone 124 to facilitate transmission of audio signals 510 between the two devices. Techniques are known in the art for establishing audio communication between devices using different communication protocols, such as cellular telephones 124 and STBs 102. For example, the broadcast center 110 may establish separate audio communication channels with the cellular telephone 124 (using conventional telephony protocols) and with the STB 102 (using VoIP or similar protocols).

In one embodiment, the broadcast center 110 also establishes one-way video communication with the STB 102 (e.g., from the STB 102 to the broadcast center 110). Thereafter, the broadcast center 110 captures and caches the video signals 502 in a storage device 408. The storage device 310 may be internal or external to the broadcast center 110 and may be embodied, for example, as a magnetic storage device (such as a hard disk drive), an optical storage device (such a CD-RW, DVD-RAM, etc.), or a random access memory (RAM). In one implementation, the broadcast center 110 also captures and caches the audio signals 510 in one or both directions.

The captured video and audio signals 502, 510 may be encoded in a compressed format, such as MPEG, before being stored in the storage device 408. Those skilled in the art will understand that many different types of encoding formats may be used within the scope of the invention. Alternatively, the video signals 502 may be encoded prior to receipt by the broadcast center 110 (e.g., by the STB 102), in which case the signals 502 are simply stored in the storage device 408.

In an alternative implementation, caching of the video signals 502 may occur at the video-enabled device where the video signals 502 originated. Thus, with reference to the example shown in FIG. 5, the STB 102 may cache the video signals 502 within its own internal storage device 310 (depicted in FIG. 3).

As illustrated in FIG. 6, the cached video signals 502 (and audio signals 510, if any) may be subsequently retrieved and displayed by the user of the non-video-enabled communication device (e.g., the recipient 506) or any other authorized person. In the depicted embodiment, the recipient 506 uses a terminal 602, such as a personal computer, to send a request 604 to the broadcast center 110. The terminal 602 may also be embodied as a STB 102, a videophone, a PDA, or another video-enabled device. The terminal 602 may be coupled to the broadcast center 110 by one or more of the networks discussed above, such as the broadband network 101, the Internet 112, or the telephone network 122.

The request 604 may be embodied in various formats. For example, the request 604 may include a URL (Universal Resource Locator) or other suitable locator link, which may have been previously sent to the recipient 506 by a messaging system (e.g., e-mail, instant messaging) after the communication between the STB 102 and the cellular telephone 124 was concluded.

Following receipt of the request 604, the broadcast center 110 may retrieve the encoded video signals 502 from the storage device 408 for transmission to the terminal 602 using conventional techniques. The video signals 502 may then be decoded (if not previously decoded by the broadcast center 110) and displayed on a display screen 606 associated with the terminal 602. The display screen 606 may be embodied, for example, as a cathode-ray tube (CRT) or liquid-crystal display (LCD) monitor, a television set, or the like.

In an embodiment in which audio signals 510 are cached, the audio signals 510 may also be retrieved from the storage device 408 and sent to the terminal 602. Upon receipt of the audio signals 510, the terminal 602 may decode and output the audio signals 510 to one or more speakers 608. Preferably, the audio signals 510 are output synchronously with the display of the video signals 502.

The video and audio signals 502, 510 may be retrieved and presented using standard hardware and software. For example, a standard Web browser running on the terminal 602, such as Microsoft Internet Explorer®, may send the request 604 to the broadcast center 110. In one implementation, the Web browser displays the retrieved video and audio signals 502, 510 using a plug-in module, one particular example of which is RealPlayer® available from RealNetworks, Inc. of Seattle, Wash.

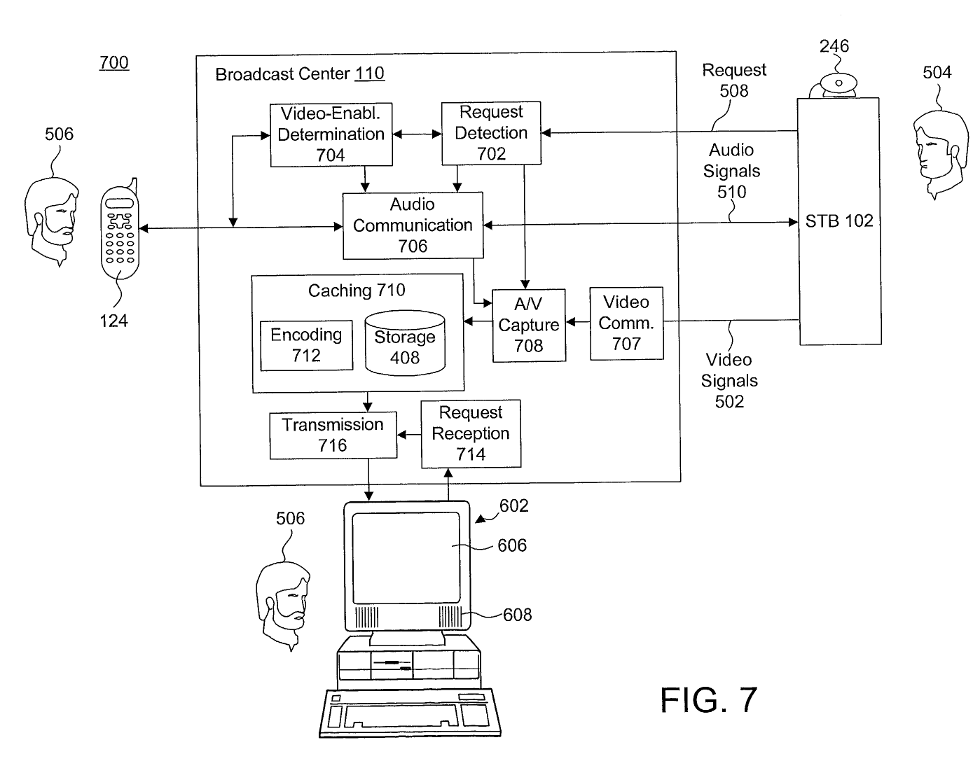

FIG. 7 is a block diagram of logical components of a system 700 for enabling communication between video-enabled and non-video-enabled communication devices. The depicted logical components may be implemented using one or more of the physical components shown in FIGS. 3 and 4. In certain embodiments, various logical components may be implemented as software or firmware. Those skilled in the art will recognize that various illustrated components may be combined together or integrated with standard components in different configurations without departing from the scope or spirit of the invention.

In one implementation, a request detection component 702 detects the request 508 to establish video communication between a video-enabled communication device (such as an STB 102) and a non-video-enabled device (such as conventional cellular telephone 124), as previously described in connection with FIG. 5.

A video-enablement determination component 704 then determines that the cellular telephone 124 is not capable of displaying video. As previously noted, the determination may be made by querying the non-video-enabled device or by maintaining a database of device capabilities.

Thereafter, an audio communication component 706 establishes two-way audio communication between the STB 102 and the cellular telephone 124, as discussed in FIG. 5, using conventional techniques. Similarly, a video communication component 707 establishes one-way video communication from the STB 102 to the broadcast center 110.

In one embodiment, an audio/video (AN) capture component 708 captures the video signals 502 (and, optionally, the audio signals 110) generated by the STB 102 during the two-way audio communication. The AN capture component 708 then provides the captured signals 502, 510 to a caching component 710, which caches the signals 502, 510 within a storage device 408. In one embodiment, the caching component 710 includes an encoding component 712 that encodes the captured 502, 510 in compressed format (e.g. MPEG), assuming the signals 502, 510 were not previously encoded.

As described in connection with FIG. 6, a request reception component 714 may later receive a request 604 from a terminal 602, such as a PC or videophone. The request reception component 714 may be in communication with a transmission component 716 that, in response to the request 604, retrieves the cached video signals 502 (and audio signals 510, if any) to the requesting terminal 602 for display/playback on a display screen 606 and speakers 608.

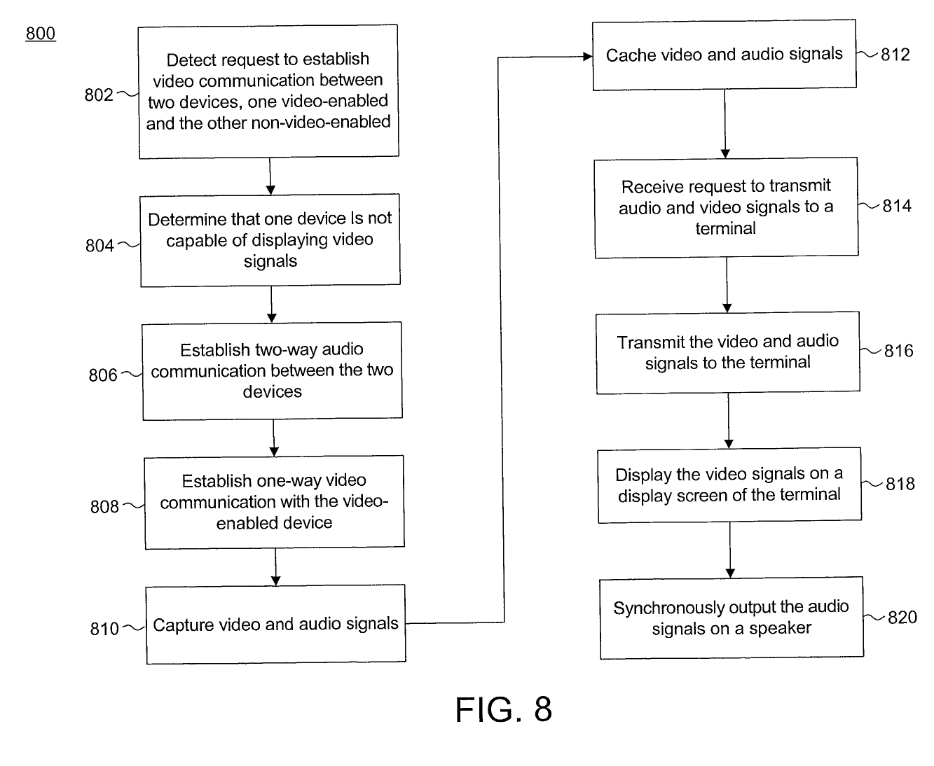

FIG. 8 is a flowchart illustrating a method 800 for enabling communication between video-enabled and non-video-enabled communication devices. The method 800 begins by detecting 802 a request 508 to establish video communication between a video-enabled (e.g., STB 102) and non-video-enabled (e.g., cellular telephone 124) communication device. Thereafter, a determination 804 that one device, the cellular telephone 124, is not capable of displaying video signals 502.

Next, two-way audio communication is established 806 between the two devices. In addition, one-way video communication with the video-enabled device is established.

During the two-way audio communication, video and audio signals 502, 510 may be captured 810 and then cached 812. In an alternative embodiment, only the video signals 502 are captured 810 and cached 812.

Subsequently, a request 604 to transmit the video and audio signals 502, 510 is received 814. As discussed previously, the request 604 may be sent by a terminal 602, such as a personal computer, or other video-enabled device. The video and audio signals 502, 510 are then transmitted 816 to the terminal 602, where they are displayed/played back on a display screen 606 and speakers 608.

Based on the foregoing, the present invention offers a number of advantages not available in conventional approaches. Communication may be established between video-enabled and non-video-enabled communication devices. Moreover, video information generated by the video-enabled device is not lost. Rather, the video information is cached for subsequent retrieval and display by the user of the non-video-enabled device or other authorized party.

While specific embodiments and applications of the present invention have been illustrated and described, it is to be understood that the invention is not limited to the precise configuration and components disclosed herein. Various modifications, changes, and variations apparent to those skilled in the art may be made in the arrangement, operation, and details of the methods and systems of the present invention disclosed herein without departing from the spirit and scope of the invention.

What is claimed is:

1. A method for enabling communication between video-enabled and non-video-enabled communication devices, the method comprising:
detecting a request to establish video communication between a first device and a second device;
determining that the second device is not capable of displaying video signals;
establishing two-way audio communication between the first and second devices;
establishing one-way video communication with the first device;
capturing video signals generated by the first device during the two-way audio communication; and
caching the captured video signals for subsequent display after the two-way audio communication is concluded.

2. The method of claim 1, further comprising:
capturing audio signals generated by the first and second devices during the two-way audio communication; and
caching the captured audio signals.

3. The method of claim 1, further comprising:
receiving a request from a terminal to transmit the cached video signals;
retrieving the cached video signals from a storage device; and
transmitting the video signals to the terminal.

4. The method of claim 3, wherein the request to transmit the cached video signals comprises a locator link indicating a stored location of the cached video signals.

5. The method of claim 4, wherein the locator link comprises a Universal Resource Locator (URL).

6. The method of claim 4, wherein caching comprises:
transmitting the locator link to a user of the non-video-enabled device.

7. The method of claim 6, wherein the locator link is transmitted to the user via a messaging system.

8. The method of claim 3, wherein the terminal comprises a display screen, the method further comprising:
displaying the video signals on the display screen of the terminal.

9. The method of claim 2, further comprising:
receiving a request from a terminal to transmit the cached video and audio signals;
retrieving the cached video and audio signals from a storage device; and
transmitting the video and audio signals to the terminal.

10. The method of claim 9, wherein the terminal comprises a display screen and a speaker, the method further comprising:
displaying the video signals on the display screen of the terminal; and
synchronously outputting the audio signals on the speaker of the terminal.

11. The method of claim 1, wherein caching comprises:
encoding the video signals in a compressed format; and
storing the encoded video signals in a storage device.

12. The method of claim 11, wherein the compressed format comprises a form of predictive coding such as MPEG video compression.

13. The method of claim 11, wherein the storage device is selected from the group consisting of a magnetic storage device, an optical storage device, and a random access memory (RAM).

14. The method of claim 1, wherein the first device comprises a camera for capturing video signals.

15. The method of claim 1, wherein the first device is selected from the group consisting of a video-enabled telephone, a video-enabled cellular telephone, a video-enabled personal computer, a video-enabled interactive television (ITV) system, and a video-enabled personal digital assistant (PDA).

16. The method of claim 1, wherein the second device is selected from the group consisting of a non-video-enabled telephone, a non-video-enabled cellular telephone, a non-video-enabled personal computer, a non-video-enabled interactive television (ITV) system, and a non-video-enabled personal digital assistant (PDA).

17. The method of claim 1, wherein the video signals are cached by a server coupled to the first and second devices by at least one network.

18. The method of claim 17, wherein the at least one network comprises a cable television network, a direct satellite broadcast (DBS) network, a wide-area network (WAN), a local-area network (LAN), a telephone network, and the Internet.

19. The method of claim 17, wherein the server is located within a broadcast center associated with the at least one network.

20. The method of claim 1, wherein the video signals are cached within the second device.

21. A system for enabling communication between video-enabled and non-video-enabled communication devices, the system comprising:
a request detection component configured to detect a request to establish video communication between a first device and a second device;
a video-enablement determination component configured to determine that the second device is not capable of displaying video signals;
an audio communication component configured to establish two-way audio communication between the first and second devices;
a video communication component configured to establish one-way video communication with the first device;
a video capture component configured to capture video signals generated by the first device during the two-way audio communication; and
a caching component configured to cache the captured video signals for subsequent display after the two-way audio communication is concluded.

22. The system of claim 21, further comprising:
an audio capture component configured to capture audio signals generated by the first and second devices during the two-way audio communication; and
wherein the caching component is further configured to cache the captured audio signals.

23. The system of claim 21, further comprising:
a request reception component configured to receive a request from a terminal to transmit the cached video signals;
a transmission component configured to retrieving the cached video signals from a storage device and to transmit the video signals to the terminal.

24. The system of claim 23, wherein the request to transmit the cached video signals comprises a locator link indicating a stored location of the cached video signals.

25. The system of claim 24, wherein the locator link comprises a Universal Resource Locator (URL).

26. The system of claim 24, wherein caching component is further configured to transmit the locator link to a user of the non-video-enabled device.

27. The system of claim 26, wherein the locator link is transmitted to the user via a messaging system.

28. The system of claim 23, wherein the terminal comprises a display screen, the system further comprising:
a display component configured to display the video signals on the display screen of the terminal.

29. The system of claim 22, further comprising:
a request reception component configured to receive a request from a terminal to transmit the cached video and audio signals;
a transmission component configured to retrieving the cached video and audio signals from a storage device and to transmit the video and audio signals to the terminal.

30. The system of claim 29, wherein the terminal comprises a display screen and a speaker, the system further comprising:
a display component configured to display the video signals on the display screen of the terminal; and
a speaker configured to synchronously output the audio signals.

31. The system of claim 21, wherein the caching component comprises:
an encoder configured to encode the video signals in a compressed format; and
a storage device configured to store the encoded video signals.

32. The system of claim 31, wherein the compressed format comprises a form of predictive coding such as MPEG video compression.

33. The system of claim 31, wherein the storage device is selected from the group consisting of a magnetic storage device, an optical storage device, and a random access memory (RAM).

34. The system of claim 21, wherein the first device comprises a camera for capturing video signals.

35. The system of claim 21, wherein the first device is selected from the group consisting of a video-enabled telephone, a video-enabled cellular telephone, a video-enabled personal computer, a video-enabled interactive television (ITV) system, and a video-enabled personal digital assistant (PDA).

36. The system of claim 21, wherein the second device is selected from the group consisting of a non-video-enabled telephone, a non-video-enabled cellular telephone, a non-video-enabled personal computer, a non-video-enabled interactive television (ITV) system, and a non-video-enabled personal digital assistant (PDA).

37. The system of claim 21, wherein the video signals are cached by a server coupled to the first and second devices by at least one network.

38. The system of claim 37, wherein the at least one network comprises a cable television network, a direct satellite broadcast (DBS) network, a wide-area network (WAN), a local-area network (LAN), a telephone network, and the Internet.

39. The system of claim 37, wherein the server is located within a broadcast center associated with the at least one network.

40. The system of claim 21, wherein the video signals are cached within the second device.

41. A computer program product comprising program code for performing a method for enabling communication between video-enabled and non-video-enabled communication devices, the method comprising:
detecting a request to establish video communication between a first device and a second device;
determining that the second device is not capable of displaying video signals;
establishing two-way audio communication between the first and second devices;
establishing one-way video communication with the first device;
capturing video signals generated by the first device during the two-way audio communication; and
caching the captured video signals for subsequent display after the two-way audio communication is concluded.

42. The computer program product of claim 41, further comprising:
capturing audio signals generated by the first and second devices during the two-way audio communication; and
caching the captured audio signals.

43. The computer program product of claim 41, further comprising:
receiving a request from a terminal to transmit the cached video signals;
retrieving the cached video signals from a storage device; and
transmitting the video signals to the terminal.

44. The computer program product of claim 43, wherein the request to transmit the cached video signals comprises a locator link indicating a stored location of the cached video signals.

45. The computer program product of claim 44, wherein the locator link comprises a Universal Resource Locator (URL).

46. The computer program product of claim 44, wherein caching comprises:
transmitting the locator link to a user of the non-video-enabled device.

47. The computer program product of claim 46, wherein the locator link is transmitted to the user via a messaging system.

48. The computer program product of claim 43, wherein the terminal comprises a display screen, the method further comprising:
displaying the video signals on the display screen of the terminal.

49. The computer program product of claim 42, the method further comprising:
receiving a request from a terminal to transmit the cached video and audio signals;
retrieving the cached video and audio signals from a storage device; and
transmitting the video and audio signals to the terminal.

50. The computer program product of claim 49, wherein the terminal comprises a display screen and a speaker, the method further comprising:
displaying the video signals on the display screen of the terminal; and
synchronously outputting the audio signals on the speaker of the terminal.

51. The computer program product of claim 41, wherein caching comprises:
encoding the video signals in a compressed format; and
storing the encoded video signals in a storage device.

52. The computer program product of claim 51, wherein the compressed format comprises a form of predictive coding such as MPEG video compression.

53. The computer program product of claim 51, wherein the storage device is selected from the group consisting of a magnetic storage device, an optical storage device, and a random access memory (RAM).

54. The computer program product of claim 41, wherein the first device comprises a camera for capturing video signals.

55. The computer program product of claim 41, wherein the first device is selected from the group consisting of a video-enabled telephone, a video-enabled cellular telephone, a video-enabled personal computer, a video-enabled interactive television (ITV) system, and a video-enabled personal digital assistant (PDA).

56. The computer program product of claim 41, wherein the second device is selected from the group consisting of a non-video-enabled telephone, a non-video-enabled cellular telephone, a non-video-enabled personal computer, a non-video-enabled interactive television (ITV) system, and a non-video-enabled personal digital assistant (PDA).

57. The computer program product of claim 41, wherein the video signals are cached by a server coupled to the first and second devices by at least one network.

58. The computer program product of claim 57, wherein the at least one network comprises a cable television network, a direct satellite broadcast (DBS) network, a wide-area network (WAN), a local-area network (LAN), a telephone network, and the Internet.

59. The computer program product of claim 57, wherein the server is located within a broadcast center associated with the at least one network.

60. The computer program product of claim 41, wherein the video signals are cached within the second device.

61. A method for enabling communication between an interactive television system and non-video-enabled communication device, the method comprising:
detecting a request to establish video communication between the interactive television system and the non-video-enabled communication device;
determining that the non-video-enabled communication device is not capable of displaying video signals;
establishing two-way audio communication between the interactive television system and the non-video-enabled communication device;
establishing one-way video communication with the interactive television system;
capturing video signals generated by the interactive television system during the two-way audio communication;
capturing audio signals generated by the interactive television system and the non-video-enabled communication device during the two-way audio communication;
caching the captured video and audio signals within a storage device for subsequent display and playback after the two-way audio communication is concluded;
receiving a request from a terminal to transmit the cached video and audio signals;
retrieving the cached video and audio signals from the storage device; and
transmitting the video and audio signals to the terminal for display and playback thereon.

62. A system for enabling communication between an interactive television system and non-video-enabled communication device, the system comprising:
a request detection component configured to detect a request to establish video communication between the interactive television system and the non-video-enabled communication device;
a video-enablement determination component configured to determine that the non-video-enabled communication device is not capable of displaying video signals;
an audio communication component configured to establish two-way audio communication between the interactive television system and the non-video-enabled communication device;
a video communication component configured to establish one-way video communication with the interactive television system;
a video capture component configured to capture video signals generated by the interactive television system during the two-way audio communication;
an audio capture component configured to capture audio signals generated by the interactive television system and the non-video-enabled communication device during the two-way audio communication;
a caching component configured to cache the captured video and audio signals within a storage device for subsequent display and playback after the two-way audio communication is concluded;
a request reception component configured to receive a request from a terminal to transmit the cached video and audio signals; and
a transmission component configured to retrieving the cached video and audio signals from the storage device and to transmit the video and audio signals to the terminal for display and playback thereon.

63. A system for enabling communication between video-enabled and non-video-enabled communication devices, the system comprising:
means for detecting a request to establish video communication between a first device and a second device;
means for determining that the second device is not capable of displaying video signals;
means for establishing two-way audio communication between the first and second devices;
means for establishing one-way video communication with the first device;
means for capturing video signals generated by the first device during the two-way audio communication; and
means for caching the captured video signals for subsequent display after the two-way audio communication is concluded.

64. A system for enabling communication between an interactive television system and non-video-enabled communication device, the system comprising:
means for detecting a request to establish video communication between the interactive television system and the non-video-enabled communication device;
means for determining that the non-video-enabled communication device is not capable of displaying video signals;
means for establishing two-way audio communication between the interactive television system and the non-video-enabled communication device;
means for establishing one-way video communication with the interactive television system;
means for capturing video signals generated by the interactive television system during the two-way audio communication;
means for capturing audio signals generated by the interactive television system and the non-video-enabled communication device during the two-way audio communication;
means for caching the captured video and audio signals within a storage device for subsequent display and playback after the two-way audio communication is concluded;
means for receiving a request from a terminal to transmit the cached video and audio signals;
means for retrieving the cached video and audio signals from the storage device; and
means for transmitting the video and audio signals to the terminal for display and playback thereon.
